(19) United States
(12) Patent Application Publication
(10) Pub. No.: US 2024/0190206 A1
(43) Pub. Date: Jun. 13, 2024

(54) SOLAR LOAD USAGE IN A VEHICULAR ENVIRONMENT

(71) Applicant: Affectiva, Inc., Boston, MA (US)

(72) Inventor: Panu James Turcot, Revelstoke (CA)

(73) Assignee: Affectiva, Inc., Boston, MA (US)

(21) Appl. No.: 18/531,814

(22) Filed: Dec. 7, 2023

Related U.S. Application Data
(60) Provisional application No. 63/431,057, filed on Dec. 8, 2022.

(51) Int. Cl. B60H 1/00

(52) U.S. Cl. CPC B60H 1/0075; B60H 1/00742

(57) ABSTRACT

Disclosed embodiments provide techniques for solar load usage in a vehicular environment. One or more processors are used to detect at least one individual in a vehicle. Sunlight contact is detected on each individual in the vehicle. A three-dimensional model of each individual in the vehicle is dynamically developed to estimate the total sunlit surface of the individual. A sunlight intensity metric is calculated based on detected sunlight. A shade intensity metric is also calculated and compared to the sunlight intensity metric. The thermal load for each individual in the vehicle is determined based on the sunlight intensity metric. The thermal load determination takes the time of day, length of exposure, and the location of sunlight into account. Climate control within the vehicle is adjusted to compensate for the determined thermal load. Climate control can be adjusted for each individual based on the thermal load determined for the individual.

### RELATED APPLICATIONS

This application claims the benefit of U.S. provisional patent application “Solar Load Usage In A Vehicular Environment” Ser. No. 63/431,057, filed Dec. 8, 2022.

The foregoing application is hereby incorporated by reference in its entirety.

### FIELD OF ART

This application relates generally to solar load analysis and more particularly to solar load usage in a vehicular environment.

### BACKGROUND

Transportation is one of the fundamental building blocks of any growing civilization. From ancient times, roads, bridges, and navigable waterways have been vital components to the circulation and expansion of goods and services, the movement of armies and navies, and the ability to interact with other people groups and nations. As technology has advanced, the means and modes of transportation have progressed as well. Human and animal-powered methods of movement have given way to machines as varied as cars, trucks, trains, barges, motorboats, airplanes, and even rockets. Humans can now travel across and under water, through the air, and in outer space, as well as over land, with increasing speed and safety.

The vehicles used for transportation have become more specialized as well as technically advanced. Goods and raw materials can be hauled in various quantities by trucks, train cars, barges, and transport planes specifically designed to handle many different types of payloads. Refrigerated trucks and railway cars can move perishable items hundreds or thousands of miles without spoilage. Livestock can be moved in mobile pens designed to keep the animals safe as well as fed and watered during transport. Ores are routinely moved by barges pushed or pulled by tugs, or by fleets of specialized trucks, to refineries many miles away from their origin. Trees cultivated for wood products and paper are taken from forest to mill by logging trucks or shipped across oceans to plywood factories in other countries. Oil and natural gas used for hundreds of different products move across the globe from collection points to refineries using massive, specialized tanker vessels. Numerous very large crude carriers (VLCCs) move across the oceans each year to harness these valuable resources.

Specialized transportation methods require specialized people skills to operate them effectively. Every transportation mode includes men and women who have trained and practiced the ability to pilot, drive, fly, or steer vehicles of many different types. Flight crews include pilots, engineers, and navigators who can move military or civilian cargo and personnel across the country or around the world. Likewise, shipping includes scores of varied skills, from boat captains to deckhands. Trains have a long history of associated jobs, including engineers, brakemen, conductors, porters, and firefighters. Cars, trucks, vans, and wagons of every size and shape have led to drivers of various skills. Taxi drivers, racecar drivers, long-haul truckers, limo drivers, mechanics, tow truck drivers, and delivery specialists work in countries around the globe.

As the transportation industry has grown and matured, the need for automation has become more pronounced. Larger loads of goods require more careful management and monitoring. The volume of passenger and cargo planes flying on a daily basis requires a sophisticated network of ground control technology and staff, as well as specialized equipment and personnel on board the aircraft. Ships moving across oceans and lakes require precise navigation and tracking in order to get from one port to another and to move through sometimes crowded docking areas safely. Train traffic is closely monitored and controlled by networks of switches, lights, cameras, and control equipment to ensure that cars are moved to the correct track at the proper time. In every mode of transportation, humans, and the technology they use, continue to adapt and advance in order to move raw materials, goods, and passengers from here to there.

### SUMMARY

Techniques for solar load usage in a vehicular environment are disclosed. Demand for automation in vehicle operation has increased substantially, expanding the requirement for improved climate control based on environmental factors. Sunlight is a significant factor affecting the thermal comfort of vehicle occupants. Determining the solar load on one or more occupants of a vehicular environment allows adjustments to climate control based on the overall thermal load on each occupant individually.

Disclosed embodiments provide techniques for solar load usage in a vehicular environment. One or more processors are used to detect at least one individual in a vehicle. Sunlight contact is detected on each individual in the vehicle. A three-dimensional model of each individual in the vehicle is dynamically developed to estimate the total sunlit surface of the individual. A sunlight intensity metric is calculated based on detected sunlight. A shade intensity metric is also calculated and compared to the sunlight intensity metric. The thermal load for each individual in the vehicle is determined based on the sunlight intensity metric. The thermal load determination takes the time of day, length of exposure, and the location of sunlight into account. Climate control within the vehicle is adjusted to compensate for the determined thermal load. Climate control can be adjusted for each individual based on the thermal load determined for the individual.

A computer-implemented method for solar load analysis is disclosed comprising: detecting, using one or more processors, at least one individual in a vehicular environment; sensing sunlight contact with the at least one individual; calculating a sunlight intensity metric, wherein the sunlight intensity metric is based on the sensing; determining a thermal load, on the at least one individual, wherein the thermal load results from the sunlight contact and wherein the determining is based on the sunlight intensity metric; and adjusting the climate control within a vehicle, from the vehicular environment, based on the determining the thermal load, wherein the adjusting compensates for the thermal load. In embodiments, the determining further comprises a three-dimensional model of the at least one individual. In embodiments, the determining is accomplished dynamically. In embodiments, the determining further comprises estimating the total sunlit surface area of the at least one individual, and the estimating is based on the three-dimensional model. And in embodiments, the estimating includes sunlight intensity per surface area of the at least one individual, wherein the sunlight intensity per surface area is based on the sunlight intensity metric.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for solar load usage in a vehicular environment.

FIG. 2 is a flow diagram for enabling solar load usage in a vehicular environment.

FIG. 3 is an infographic for illustrating solar load.

FIG. 4 is an example of sunlight coverage changes due to angle of incidence of the sun.

FIG. 5 is an infographic of splitting and comparing images.

FIG. 6 is an infographic of estimating a sunlight intensity per surface area metric.

FIG. 7 is an infographic for adjusting the climate control in a vehicle.

FIG. 8 is a system diagram for solar load usage in a vehicular environment.

### DETAILED DESCRIPTION

Automation is more and more a part of vehicle design and development. As the number of vehicles on our motorways increases, the need for better safety in the vehicles themselves becomes essential. In addition, the complexity of the vehicles, the value and volume of the payloads, and the requirement for efficient routing all contribute to the necessity of automation to help control the vehicles safely and to minimize distractions to the operators. Digital readouts and heads-up displays are replacing simple analog displays. Computer sensors throughout the vehicle monitor engine and drivetrain performance. Cameras and radars display the area surrounding the vehicle for backing up safely and, more recently, slowing down or stopping the car in an emergency. Navigation systems and safety monitoring, which are either linked to mobile devices or directly incorporated into the vehicles, are becoming standard equipment. Other sensors use road markings to notify the driver of lane changes, drifting due to distractions, or falling asleep. In some newer cars, highway steering, lane changes, adjusting speed to surrounding traffic, and parallel parking are all automation options.

Along with these features, vehicle climate control is becoming increasingly automated. Climate controls can provide electronic regulation of air temperature, airflow rate, and air distribution based on occupant preferences. Once a desired temperature is selected, climate control systems manage heat, cooling, airflow rate, and flow direction in order to maintain the requested temperature. Some systems include dual-zone climate control with automatic air recirculation, allowing the system to bring in air from outside the vehicle or to intensify the heating or cooling of the air already inside the vehicle. In addition, some systems control the defroster nozzles for the windshield and side windows to eliminate fogging. Fogging occurs when warm, humid air inside of the vehicle cools and contracts as it contacts the relatively cooler windows. This leads to moisture condensing on the inside surface of the glass. Raising the surface temperature of the glass by directing warm air through the defroster nozzles evaporates the condensed moisture and eliminates the fog. More advanced climate control systems provide four-zone controls, allowing rear cabin passengers to adjust their vehicle cabin sections from a console in the rear-center armrest or on the back of the center console. Other systems include air conditioning for the glovebox to allow stored water bottles and beverage cans to be cooled. Climate control is more than a convenience for drivers and passengers. Since the console for climate control is usually placed in the center of the dashboard, driver distraction is a genuine safety concern. Distracted driving is one of the leading causes of motor vehicle accidents, causing more than 3,000 deaths and nearly 400,000 injuries annually in the U.S. Nearly eighty percent of drivers admit to some form of distracted driving, including adjusting the sound system or climate controls while the vehicle is in motion. Climate control systems are designed to regulate temperature without intervention by the driver once the desired temperature has been selected. This allows the driver to maintain focus on the road rather than making adjustments to the heat or air conditioning controls. Thus, improving the effectiveness of vehicle climate control benefits both the occupants and traffic safety in general.

Techniques for solar load usage in a vehicular environment are disclosed. First, at least one individual is detected in a vehicular environment using one or more processors within the vehicle. The processors can be infrared radiation (IR) sensors, non-contact thermal sensors, thermal imaging sensors, Red-Green-Blue (RGB) cameras, or RGB-IR cameras. The one or more processors can be distributed throughout the vehicular environment and can be used in combination with one another. Once the individuals in the vehicle have been detected, the sensors can be used to recognize the presence of sunlight contact on each occupant. The various sensors collect different types of information about the vehicle occupants: IR sensors detect infrared radiation levels, thermal sensors register surface temperatures, and RGB cameras gather light and color information. RGB images can be split into separate red, green, and blue channels, resulting in three greyscale images. Greyscale images use pixels to register varying light levels on a scale from 0 to 255, with the higher numbers indicating more light. The information from the sensors can be used to calculate a sunlight intensity metric. The sunlight intensity metric is a numeric representation of the magnitude of sunlight brightness. This metric can be used in later steps to determine the intensity of sunlight on the one or more individuals in the vehicle, and to calculate the solar load on the individuals leading to increased temperatures.

A three-dimensional model of each individual detected in the vehicular environment can be developed and used to determine the total sunlit surface area of the occupants. Once the model is constructed, it can be divided into segments. Then, each segment can be assigned a sunlight intensity value using the calculated sunlight intensity metric or value. After each segment has been assigned a sunlight intensity value, the total sunlit surface area can be estimated. The estimate can be used to determine the solar load on each individual in the vehicular environment based on the percent of sunlight coverage on each occupant. Solar load is a measurement of the increase in temperature of an object due to exposure to sunlight. It is a component of the total thermal load on an individual in a vehicular environment. Thermal load considers all factors that contribute to an increase in temperature of an object, such as an individual, in a vehicle. The solar load can be adjusted to account for the time of day. The time of day allows the solar load calculation to reflect the sun's angle, which can affect the thermal load delivered by sunlight to each individual. When the sun's relative position is close to either horizon, the sunlight is diffused by greater amounts of atmosphere resulting in less intense exposure to the individuals within a vehicle. Even when the total surface area of sunlight exposure on an individual increases, the lower intensity of the sunlight in early morning or later evening can result in lower solar load. The solar load can also be changed by recognizing the clothing on each individual and the thermal properties of the clothing being worn. Machine learning can be used to store and update the thermal properties of various articles of clothing. For example, dark wool or wool blends store more heat from sunlight than light-colored cotton fabrics. The amount of clothing worn by an individual, combined with the thermal properties of the clothing being worn, can significantly affect the accumulated solar load.

Once the solar load is determined for each individual, the climate control in the vehicular environment can be adjusted. In vehicles with separate controls for each individual, independent adjustments can be made. Vehicles with a single control for the entire interior can be adjusted based on the aggregate solar load determined for all occupants. As the solar load changes on the individuals over time, climate control can be adjusted dynamically. The climate control adjustment can consider window position, seat heaters, exterior temperature, and occupant preferences based on their position in the vehicular environment. Machine learning can be used to develop and refine user preferences for temperature, airflow, and other vehicle climate factors so that the individuals in a vehicle make adjustments to the climate control less often over time.

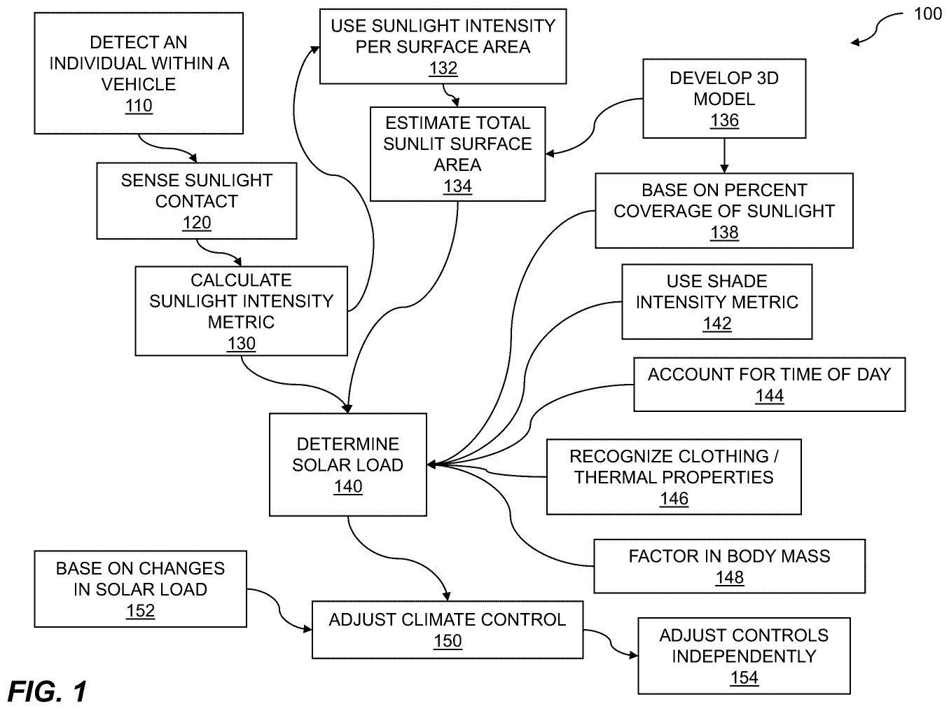

FIG. 1 is a flow diagram 100 for solar load usage in a vehicular environment. At least one individual can be detected in a vehicular environment by one or more sensors placed in the vehicle. Sunlight contact with the vehicle occupants is sensed, and a sunlight intensity metric is calculated based on the sensed sunlight contact. A three-dimensional model of each individual can be dynamically developed and used to estimate the total sunlit surface area based on the sunlight intensity metric. A shade intensity metric can be determined and compared with the sunlight intensity metric to calculate the percentage of sunlight coverage on the individuals. The sunlight intensity metric can be combined with the percentage of sunlight coverage to determine the thermal load on the occupants. The thermal load determination can include accounting for the time of day, length of sunlight exposure, location of sunlight, recognized clothing, and thermal properties of the clothing. After the thermal load resulting from sunlight contact has been determined, climate control in the vehicular environment can be adjusted based on the increased thermal load. Climate control can be adjusted dynamically based on changes in thermal load. Periodic calculations of solar load on the one or more individuals in the vehicle can result in progressive changes to climate control over the length of each trip. In vehicles with separate climate control settings for each occupant, the control can be individually adjusted based on the determined thermal load for each occupant. Machine learning can be used to develop preferences for each occupant to record and refine adjustments to climate control over time.

The flow 100 includes detecting an individual within vehicle 110. In embodiments, more than one individual may be identified. The detecting can be accomplished with one or more processors. The processors can be placed in various areas within the vehicle. In some embodiments, the detecting can be accomplished by an IR sensor, non-contact thermal sensor, thermal imaging sensor, RGB camera, or RGB-IR camera. One or more processors can be used to sense sunlight contact 120 on at least one individual in the vehicle. The sensing can be accomplished by an IR sensor, a non-contact thermal sensor, a thermal imaging sensor, an RGB camera, or an RGB-IR camera. In some embodiments, an RGB image can be split into red, green, and blue (RGB) channels, resulting in three greyscale images. A greyscale image captures the intensity of light in pixels. The intensity values are discrete integers ranging from 0 as the lowest or darkest intensity to 255 as the highest or brightest intensity. A second color RGB image can be split into three RGB channels, and the resulting greyscale images can be compared to those from the first RGB image based on pixel intensity. The greyscale image comparison can include a threshold value. The time elapsed between when the first color image is captured and when the second color image is captured can be variable. The change in pixel intensity between the greyscale images can be used to adjust the sensed sunlight contact.

The flow 100 includes calculating a sunlight intensity metric 130, based on the sensed sunlight contact 120. In embodiments, the sensors or cameras in the vehicle used to detect and sense at least one individual can provide different data to calculate the sunlight intensity metric. IR sensors detect infrared light radiated by a source, such as an individual in a vehicle. In some embodiments, the IR sensor can be active. An active IR sensor emits IR radiation of a specific wavelength and detects the IR radiation reflected from an object. The detected radiation is then processed based on its intensity. The intensity values can then be conveyed to a calculating component for the sunlight intensity metric. A passive IR sensor (PIR) only detects IR radiation reflected from an object, such as an individual in a vehicle being contacted by sunlight. The detected IR radiation from the individual can then be processed based on its intensity and the values can be conveyed to the calculating component. A non-contact thermal sensor detects the surface temperature of an object based on an optical analysis of the IR radiation emitted by the object. The IR radiation is focused through a lens in the sensor onto a detector which translates it into an electrical signal. The resulting temperature values can then be conveyed to the calculating component for the sunlight intensity metric. A thermal imaging sensor works similarly to a non-contact thermal sensor. Surface temperatures of an individual are detected based on an optical analysis of the IR radiation emitted by one or more individuals in a vehicle. Direct or diffused sunlight striking an individual causes the individual to emit higher levels of IR radiation. The radiated IR light is focused through a lens in the sensor onto a detector which translates it into an electrical signal. The resulting temperature values can then be conveyed to the calculating component for the sunlight intensity metric. RGB cameras can be used as described earlier. The red, green, and blue signals can be split, and the resulting greyscale images can be used to capture the light intensity in pixels. The light intensity values can be forwarded to the calculating component for the sunlight intensity metric.

The flow 100 includes using sunlight intensity per surface area 132. In embodiments, a three-dimensional model is developed for each individual detected in the vehicle 136. The three-dimensional models are developed dynamically and updated as time elapses. After each three-dimensional model is developed, the model's surface area is divided into sections, and the sunlight intensity is estimated for each section using the sunlight intensity metric. The total sunlit surface area is estimated 134 based on the sunlight intensity calculated for each section of the three-dimensional model. In some embodiments, a shade intensity metric 142 can also be calculated based on the light intensity values captured by the sensors mentioned above. For example, greyscale images can be analyzed for light intensity expressed in pixel values from 0 to 255. Values 0 to 50 can be assigned dark, 51 to 100 full shade, 101 to 150 partial shade, 151 to 200 partial sunlight, and 201 to 255 full sunlight. Using values like these assigned to each section of the three-dimensional model, the percentage coverage of sunlight 138 can be calculated. The higher the percentage of sunlight exposure to the three-dimensional model, the higher the solar load calculated for each individual in the vehicle.

The sunlight intensity metric 130, the shade intensity metric 142, and the estimated total sunlit surface area 134 can be used to determine the solar load 140 on each individual in the vehicle. Solar load is a measurement of the temperature elevation of an object, such as an individual in a vehicle, due to exposure to sunlight over time. In some embodiments, the solar load determination can consider the time of day, the incidence angle of the sun, the length of exposure, and the location of sunlight on the individuals in the vehicle 144. These elements can be used to adjust the solar load calculation positively or negatively. For instance, sunlight contact between 11:30 a.m. and 1:30 p.m. can be weighted positively to account for more direct contact and higher intensity. Conversely, sunlight contacting an individual from the side at 5:00 p.m. can be weighted negatively for more oblique contact, lower intensity, and so on.

In the flow 100, the determining the solar load 140 can include recognizing clothing on the individuals in the vehicle and determining the thermal properties of the clothing 146. Recognizing clothing on the individuals in the vehicle can be accomplished dynamically. Changes in the two-dimensional and three-dimensional models of each individual in the vehicle can be used to identify clothing being worn. RGB color analysis can also be used to identify clothing worn by an individual in the vehicle. Machine learning can be used to record and refine information regarding clothing worn by individuals in the vehicle. Dynamic updating of the solar load on each individual in a vehicle allows the solar load calculation to consider individuals adding or removing clothing articles such as a jacket, coat, or hat, for example. In some embodiments, recognizing clothing and the thermal properties of clothing can be based on machine learning. Machine learning can be used to record and refine information regarding articles of clothing worn by individuals. Information about the percentage of an individual's body covered, thermal properties of the clothing, etc., can be stored and recalled to update and modify the calculated solar load on each individual in the vehicle. The determining the solar load 140 can also include factoring in an individual's body mass 148. The body mass of each individual in the vehicle can be included either separately or together as part of the solar load determination. One or more body masses can be estimated based on the apparent volume of the individual, as calculated from the 3D model, and then paired with clothing analysis discussed above. The body mass can be weighted differently for different individual mass ranges. For example, an obese vehicle occupant may require additional cooling in a high solar load environment when compared to a slender vehicle occupant. In embodiments, the determining includes factoring in an estimated body mass of the at least one individual.

The flow 100 includes adjusting climate control 150 based on the determined solar load on the at least one individual in the vehicle. In embodiments, the adjusting can be accomplished dynamically based on changes in solar load over time 152. In some embodiments, vehicles that include independent temperature controls for each individual can be adjusted independently 154. In some vehicles, independent climate control zones can be established for more than two individuals. Separate controls for individuals in the rear seat can be used to adjust air temperature and flow. Independent adjustments for each individual in the vehicle can be made based on user preferences and calculated solar loads. In some vehicles, adjusting the climate control can include adjusting the transparency of one or more windows in the vehicle. For example, on a bright, sunny, open highway, the one or more windows can be darkened to reduce solar load. This aspect of climate control can be adjusted in conjunction with and/or separate from the more traditional climate controls. In some embodiments, the adjusting can be based on a profile established for each individual in the vehicle. The profile can include a preference for temperature, airflow, and window position. The adjusting can include the time of day, season, time of year, drive time, geographic location, make and type of vehicle, etc. The adjusting can also include opening a window in the vehicle, using a seat heater or seat cooler, etc. Machine learning can be used to record a user profile for each individual in the vehicle considering comfort preferences, clothing being worn, vehicle capabilities, geography, weather, and other environmental factors. The result can be that one or more individuals using a particular vehicle routinely over time need not adjust the climate control when using the vehicle. In some embodiments, the machine learning user profile can be implemented by multiple vehicles so that a recognized individual can use the same or similar climate control settings as they move from one vehicle to another.

Various steps in the flow 100 may be changed in order, repeated, omitted, or the like without departing from the disclosed concepts. Various embodiments of the flow 100 can be included in a computer program product embodied in a non-transitory computer-readable medium that includes code executable by one or more processors. Various embodiments of the flow 100, or portions thereof, can be included on a semiconductor chip and implemented in special purpose logic, programmable logic, and so on.

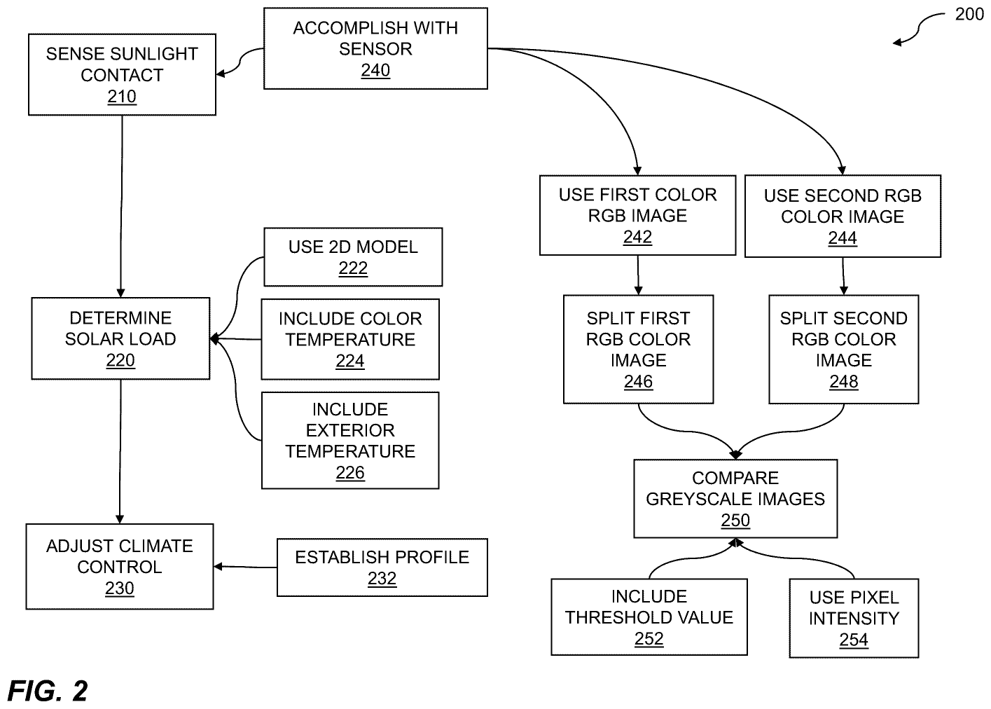

FIG. 2 is a flow diagram for enabling solar load usage in a vehicular environment. As discussed above and throughout, individuals in a vehicle can be exposed to sunlight while occupying the vehicle. In addition, sensors placed in various locations throughout the vehicle's interior can be used to sense sunlight contact on the individuals. In some embodiments, RGB or RGB-IR cameras can detect sunlight contact. Images of the occupants can be taken at different time intervals and can then be compared. The red, green, and blue images can be split into three channels, resulting in three greyscale images. Greyscale images convert each color channel into black, white, and 254 different shades of grey using a mathematical formula to assign each colored pixel the closest greyscale equivalent. The higher the value, the lighter the shade of grey, with pure black being 0 and pure white being 256. In some cases, a threshold value can be assigned to simplify the sunlight or shade determination. A pixel intensity calculation may also be used. Pixel intensity determines the number of pixels at or near the extreme ends of the 0 to 256 range. For example, the larger the number of pixels with a value of 256, the more intense the sunlight is in that area.

Once the sunlight intensity and exposure area have been determined, the solar thermal load can be calculated for each individual in the vehicle. In some embodiments, the determination can be based on a two-dimensional model of the individuals in the vehicle. The color temperature can also be included in determining the solar load. Color temperature measures the color of a light source, such as the sun, measured in Kelvin. The higher the value of the color temperature, the whiter the light. For example, full daylight has a color temperature of 7000K. Using a known color within the vehicle for calibration, the color temperature setting required to match the template color can provide information regarding the brightness of the sunlight contacting the individuals within the vehicle. Additionally, the exterior temperature around the vehicle can be used to adjust the solar load determination.

After the solar load for all individuals in the vehicle has been determined, the climate control for each occupant can be adjusted. In some embodiments, a profile for each occupant can be recorded so that the individual temperature and airflow preferences can be used to adjust the climate control.

The flow 200 includes sensing sunlight contact 210 with at least one individual in a vehicle. In embodiments, the sunlight contact sensing is accomplished with one or more sensors 240 placed in the vehicular environment. The sensors can be IR sensors, non-contact thermal sensors, thermal imaging sensors, RGB cameras, or RGB-IR cameras. IR sensors detect infrared radiation from the surface of the at least one individual in the vehicle. The IR sensor can be active, in which the sensor projects infrared light toward an individual and then detects the reflected infrared radiation. In some embodiments, the IR sensor can be passive, in which the sensor only detects infrared radiation reflected from the individual. Non-contact thermal sensors and thermal imaging sensors both detect the surface temperatures of various portions of the individuals in the vehicle. RGB and RGB-IR cameras record color images of the individuals in the vehicle.

The flow 200 includes the use of multiple color RGB images to detect changes in the level of sunlight contact of individuals in a vehicle. As discussed above, sunlight contact is sensed 210 by one or more sensors within the vehicle 240. In some embodiments, an RGB or RGB-IR camera is used to accomplish the sensing. The first color RGB image captured by the RGB camera is used 242 to establish the amount of sunlight contact on each individual in the vehicle. The first RGB color image is split into red, green, and blue channels 246, which results in three greyscale images. Greyscale images are expressed in the form of pixels with numeric values from 0 to 255. 0 is used to represent a pure black pixel, 255 is used to represent a pure white pixel, and 1 to 254 are used to represent progressively lighter shades of grey as the numeric value increases. Each of the three-color channels is converted to greyscale images. After a variable length of time, a second RGB color image is used 244. As with the first RGB image, the second RGB color image is split 248 into three separate red, green, and blue channels, resulting in three greyscale images. After the three greyscale images have been produced from both the first and second RGB images, the images are compared 250—red to red, green to green, and blue to blue. In some embodiments, pixel intensity 254 can be used in the comparison. Pixel intensity considers the number of pixels with the same or similar values distributed across a specific image area. For example, the area of an individual's face in the first greyscale image might be exposed to full sunlight. In this case, the greyscale pixels shown across the area of the face can range in value from 225 to 255, indicating bright to very bright sunlight contact. The amount or intensity of sunlight contact can be different in the second color RGB image. For example, the sunlight can be partially or wholly obscured by clouds, trees, or buildings. In this case, the greyscale pixels across the same individual's face can range in value from 150 to 215, indicating a lower amount of sunlight and less intensity. In some embodiments, a threshold value 252 for the greyscale pixels can also be used. Threshold values can be used to separate pixel values into two or three specific groups. For example, a threshold value for sunlight versus shade can be set at 128 so that any pixel value in a greyscale image at 128 or higher is set to 255 for full sunlight, and any greyscale image lower than 128 is set to 0. This results in a black-and-white-only image and can be used to evaluate the total percentage of sunlight and shade contact on an individual in a vehicle.

The flow 200 includes determining solar load 220. After sunlight contact has been sensed 210 on an individual in a vehicle using sensors 240 and the amount of sunlight has been estimated using greyscale images 250, the thermal load on each individual in the vehicle generated by sunlight contact can be determined. Thermal load is a measure of the amount of heat energy accumulated by an object, such as an individual in a vehicle, due to changes in the environment. In this case, sunlight contact with the at least one individual in a vehicle results in heat energy being accumulated by that individual. Thus, the thermal load due to sunlight contact on at least one individual in a vehicle comprises a solar load 220. In some embodiments, a two-dimensional model 222 can be used in determining solar load 220. A two-dimensional model allows the greyscale pixels to be laid out across the model and quickly evaluated for the percentage of sunlight and shade contacting each individual in the vehicle. In some embodiments, determining solar load can include color temperature 224. Color temperature is a measure of electromagnetic radiation in kelvin units emitted by objects such as light bulbs or the sun. The sun may appear red, orange, yellow, or white, depending on its position in the sky. The spectrum of daylight from red to bright white detected by an RGB camera can be used in estimating the amount of sunlight contact on an individual in a vehicle. In some embodiments, determining solar load can include the exterior temperature 226 around a vehicle. The temperature of the air flowing through a vehicle can affect the thermal load on the at least one individual in the vehicle.

The flow 200 includes adjusting climate control 230 in a vehicle. The solar load on the at least one individual in a vehicle can be used to adjust climate control within the vehicle. In some embodiments, the climate control can have zone adjustments so that control for the at least one individual in the vehicle is adjusted separately. In some embodiments, the solar load on each individual can be aggregated and the climate control adjusted to compensate for the total solar load on all individuals in the vehicle. The climate control adjustment can include the time of day, season, time of year, drive time, geographic location, make and type of vehicle, and capability of the climate controls. In some embodiments, a profile for the at least one individual in the vehicle can be established 232. The profile can include a preference for temperature, airflow, window position, etc.

Various steps in the flow 200 may be changed in order, repeated, omitted, or the like without departing from the disclosed concepts. Various embodiments of the flow 200 can be included in a computer program product embodied in a non-transitory computer-readable medium that includes code executable by one or more processors. Various embodiments of the flow 200, or portions thereof, can be included on a semiconductor chip and implemented in special purpose logic, programmable logic, and so on.

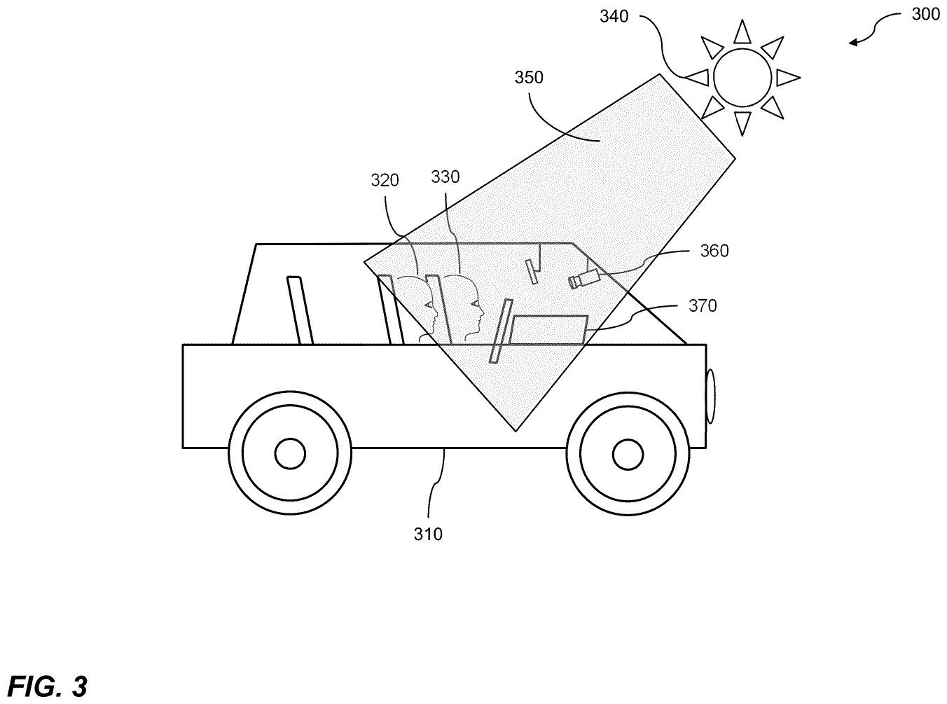

FIG. 3 is an infographic for illustrating solar load. Sunlight enters a vehicle and contacts at least one individual. The sunlight contact can be detected by IR sensors, non-contact thermal sensors, thermal imaging sensors, RGB cameras, or RGB-IR cameras placed within the vehicle. As the sunlight contacts the individuals in the vehicle, heat energy is accumulated. The heat energy is called a solar load, indicating the thermal load that can be attributed to the sunlight contact on each individual in the vehicle.

The infographic 300 includes a vehicle 310, which can accommodate at least one individual. In embodiments, the vehicle 310 includes climate control 370 that can be adjusted based on the solar load on the at least one individual in the vehicle. In the infographic 300, the sun 340 generates electromagnetic radiation in the form of infrared, visible, and ultraviolet light. Some of the sunlight is filtered and scattered by the earth's atmosphere. In the infographic 300, sunlight 350 can contact the vehicle 310 and the individuals (320 and 330) inside the vehicle. The sunlight is a combination of light and radiant heat. As the sunlight contacts the individuals within the vehicle, sensors 360 can detect the sunlight radiation reflected by the individuals. In embodiments, the sensors 360 can be IR sensors, non-contact thermal sensors, thermal imaging sensors, RGB cameras, or RGB-IR cameras placed in the front or sides of the vehicle. As the sunlight contacts the individuals 320 and 330, heat energy is accumulated by each individual. The total heat energy is measured as thermal load expressed on the Kelvin scale. The Kelvin temperature scale has no negative values, so zero Kelvin stands for “absolute zero”, which is the point where particles of matter cease all kinetic energy. This means that they cannot get any colder. Solar load is the thermal load on each individual in the vehicle that can be attributed to sunlight contact. As mentioned above and throughout, as at least one individual accumulates the solar load in a vehicle, the climate control 370 can be adjusted to compensate for the temperature rise. In some embodiments, the climate control can be adjusted for each individual separately so that the adjustment for the driver of a vehicle 330 can be different from the climate control made for a passenger 320. In other embodiments, the total solar load for all individuals in a vehicle 310 can be used to adjust the climate control 370 for the entire vehicle.

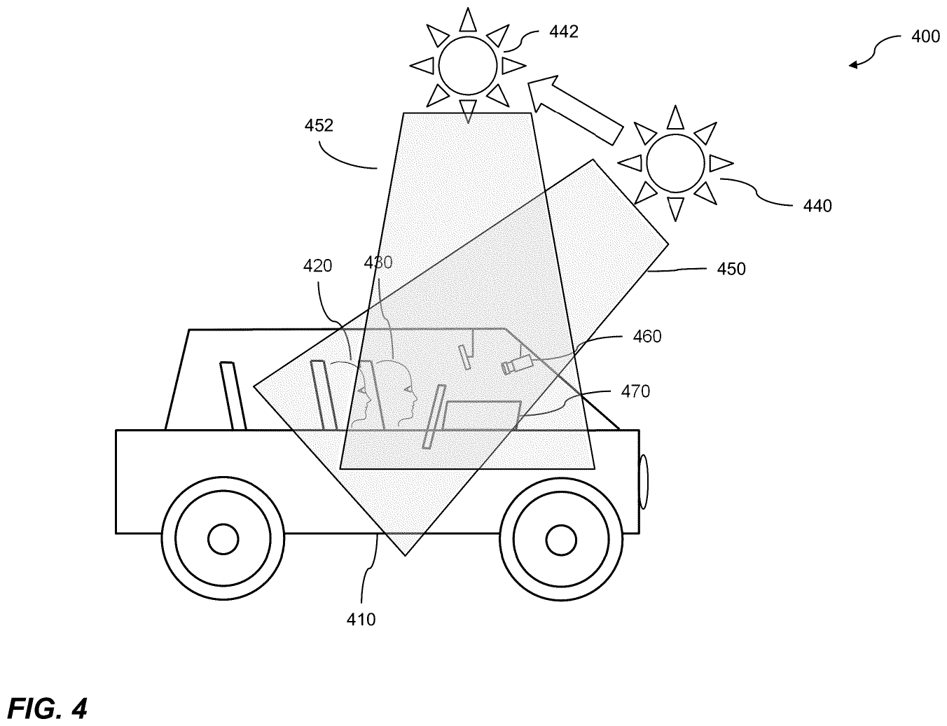

FIG. 4 is an example of sunlight coverage changes due to the incidence angle of the sun. Sunlight enters a vehicle and contacts at least one individual. The sunlight contact can be detected by IR sensors, non-contact thermal sensors, thermal imaging sensors, RGB cameras, or RGB-IR cameras placed within the vehicle. Heat energy is accumulated when the sunlight contacts at least one individual in the vehicle. The heat energy accumulated by the at least one individual in the vehicle is called a solar load, indicating the thermal load that can be attributed to the sunlight contact on each individual. As time progresses and the vehicle travels, the sun's position in the sky relative to the vehicle changes. The sunlight contact with at least one individual in a vehicle becomes more or less direct as the angle of the sun relative to the vehicle alters. As the sunlight contact surface area and intensity changes, the solar load changes as well, so that the temperature of the at least one individual in the vehicle increases or decreases. The sensors within the vehicle record the changes in sunlight contact on the at least one individual in the vehicle. Climate control is adjusted to compensate in response to changes in the determined solar load.

The FIG. 400 includes a vehicle 410 which carries at least one individual. In embodiments, the vehicle 410 includes climate control 470 that can be adjusted based on the solar load on the at least one individual in the vehicle. Climate control can include using a vehicle seat heater or cooler and opening or closing windows. In some embodiments, climate control can include independent controls for each individual in a vehicle. In the flow 400, the sun 440 generates electromagnetic radiation in the form of infrared, visible, and ultraviolet light. Some of the sunlight is filtered and scattered by the earth's atmosphere. In the flow 400, sunlight 450 can contact the vehicle 410 and the individuals (420 and 430) inside the vehicle. The sunlight is a combination of light and radiant heat. As the sunlight contacts the individuals within the vehicle, sensors 460 can detect the sunlight radiation reflected by the individuals. In embodiments, the sensors 460 can be IR sensors, non-contact thermal sensors, thermal imaging sensors, RGB cameras, or RGB-IR cameras placed in the front or sides of the vehicle. As the sunlight contacts the individuals 420 and 430, heat energy is accumulated by each individual. The total heat energy is measured as thermal load expressed on the Kelvin scale. Solar load is the thermal load on each individual in the vehicle that can be attributed to sunlight contact. As mentioned above and throughout, as at least one individual accumulates the solar load in a vehicle, the climate control 470 in the vehicle can be adjusted to compensate for the temperature rise. In some embodiments, the climate control can be adjusted for each individual separately so that the adjustment for the driver of a vehicle 430 can be different from the climate control made for a passenger 420. In other embodiments, the total solar load for all individuals in a vehicle 410 can be used to adjust the climate control 470 for the entire vehicle.

The FIG. 400 includes a change in the sun position 442 relative to the vehicle. As time progresses, the position of the vehicle changes, as does the location of the sun in the sky. The change is indicated by the arrow located between the sun 440 and 442 at different positions in the sky. As the position of the sun changes, the angle of the sunlight contact on the individuals 420 and 430 in the vehicle 410 changes. The change is indicated by the sunlight 450 and 452 at different positions in the sky. The incidence angle is the angle between a ray of light traveling in a straight line from the sun to the surface of an object and the line perpendicular to the surface of the object at the point at which the ray of light strikes. For example, in the FIG. 400, the position of the sun 440 is shown forty degrees above the horizon of the vehicle as it faces forward. This makes the incidence angle of the sunlight 450 fifty degrees. FIG. 4 further shows the position of the sun 442 at ninety degrees above the horizon of the vehicle or directly overhead. Thus, the incidence angle of the sunlight 452 is zero. The incidence angle of sunlight contacting at least one individual in a vehicle can determine the solar load on the individual. The lower the incidence angle of sunlight, the more direct the solar contact and the higher the intensity. Solar load increases with more direct, higher-intensity solar contact. As at least one individual accumulates the solar load in a vehicle, the climate control 470 in the vehicle can be adjusted to compensate for the rise in temperature. In some embodiments, the climate control can be adjusted for each individual separately so that the adjustment for the driver of a vehicle 430 can be different from the climate control made for a passenger individual 420. In other embodiments, the total solar load for all individuals in a vehicle 410 can be used to adjust the climate control 470 for the entire vehicle.

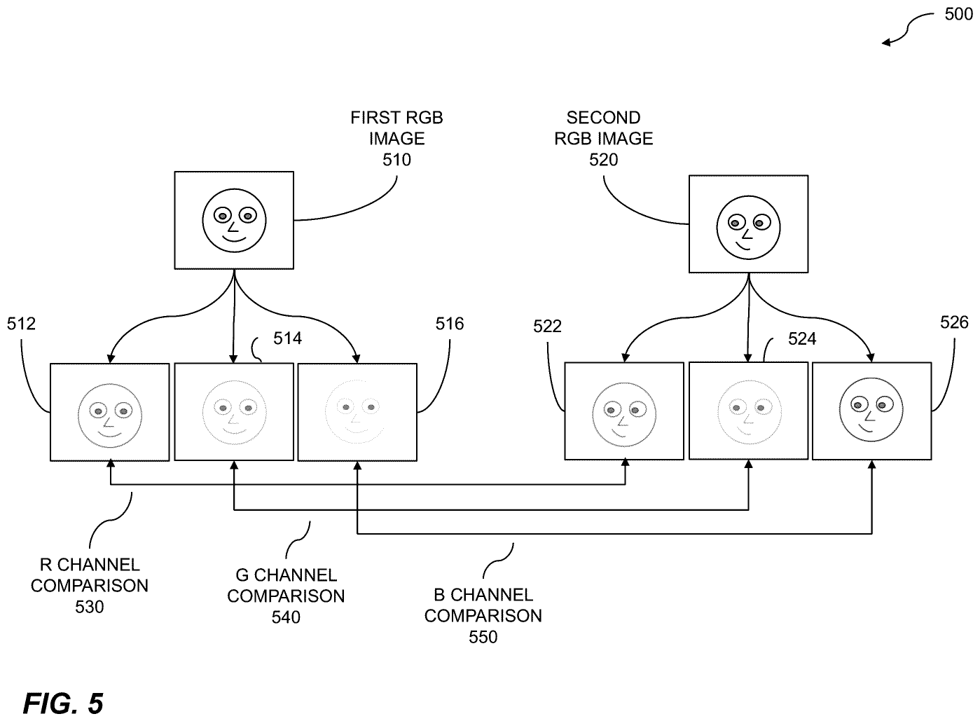

FIG. 5 is an infographic of splitting and comparing images. As mentioned previously and throughout, RGB and RGB-IR cameras can be used to sense sunlight contact on at least one individual in a vehicle. The cameras can be used to take images of the at least one individual in a vehicle. The length of time between one image being taken and the next image being taken can be varied. The first RGB color image recorded by a camera can be split into three separate red, green, and blue channels. The result of splitting the images is three greyscale images. Greyscale images are stored as pixels with values from 0 to 255. Value 0 represents a pure black pixel, value 255 is a pure white pixel, and values 1 to 254 are grey images from darkest to lightest grey represented by lower to higher values. A second RGB color image recorded at a later time can be split in the same way, resulting in three more greyscale images. The greyscale images can be compared: red channel image to red channel image, green channel image to green, and blue channel image to blue. As the level of solar contact increases and decreases on the at least one individual in the vehicle, the greyscale values on subsequent split images from the RGB cameras can be compared to previous greyscale images. The resulting changes determined by the image comparisons can be used to adjust the climate control in the vehicle.

The infographic 500 can include a first RGB color image 510 recorded by an RGB camera in a vehicular environment. In embodiments, the RGB camera can take an image of at least one individual in a vehicle. The first RGB image can be split into three channels: red 512, green 514, and blue 516. Splitting the color image into three separate color channels results in three greyscale images. Greyscale images are divided into pixels, the smallest unit of a digital image that can be displayed or represented on a digital display device. Each pixel in a greyscale image records only an amount of light, represented by a number from 0 to 255. A value of 0 represents no light or pure black. A value of 255 represents full-intensity, pure white light. The values of 1 to 254 represent various levels of grey, from darkest to lightest.

The infographic 500 can include a second RGB color image 520 recorded at a later time from the first RGB color image 510. The second RGB image can be split into three separate red 522, green 524, and blue 526 channels in the same manner as the first RGB image. The same types of greyscale images result from splitting the color channels as in the first RGB image splitting. The greyscale images from the first and second RGB images can be compared. In the infographic 500, the first red greyscale image 512 is compared to the second red greyscale image in the R channel comparison 530. The first green greyscale image is compared to the second green greyscale image in the G channel comparison 540. The first blue greyscale image is compared to the second blue greyscale image in the B channel comparison 550. As the level of solar contact changes on the at least one individual in the vehicle, the greyscale values on subsequent split images from the RGB cameras can be compared to previous greyscale images. The resulting changes determined by the image comparisons can be used to adjust the climate control in the vehicle. Details of the climate control adjustments are discussed in a later figure.

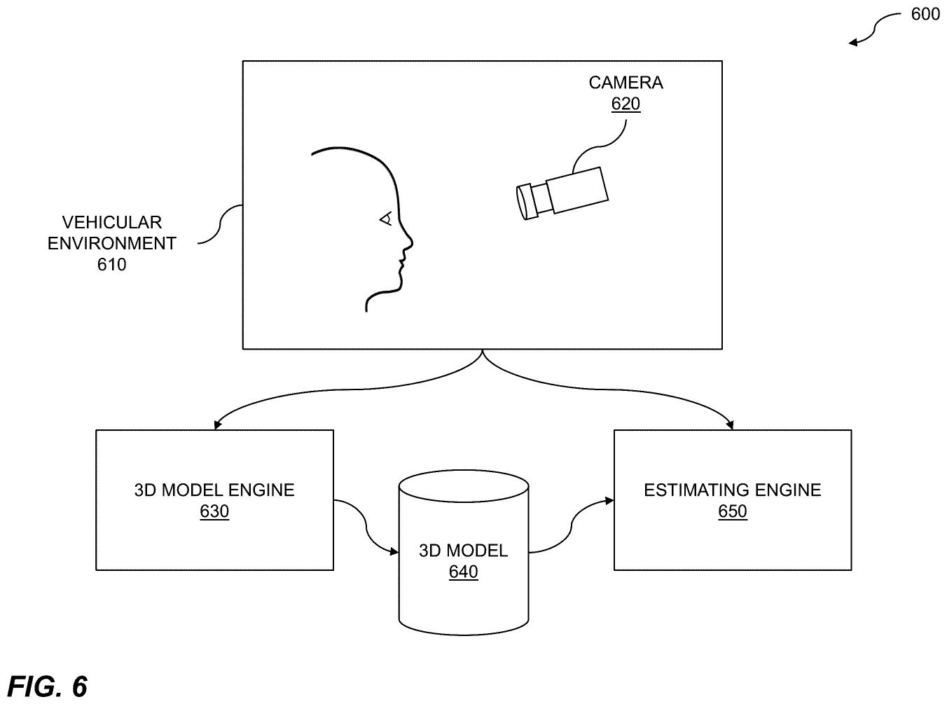

FIG. 6 is an infographic of estimating a sunlight intensity per surface area metric. As mentioned above and throughout, one or more RGB cameras can be placed in a vehicular environment. The cameras can be used to detect sunlight contact with at least one individual in the vehicle. Images from the RGB camera can be used to generate a three-dimensional model. The model can be used to estimate the total sunlit surface area and sunlight intensity of the at least one individual. The sunlight intensity per surface area metric for the at least one individual can be based on a calculated sunlight intensity metric. The sunlight intensity per surface area metric can be used to adjust the climate control. The climate control adjustment can compensate for the increase in thermal load due to sunlight contact with the at least one individual in the vehicle.

The infographic 600 can include a vehicular environment 610. In embodiments, at least one individual can occupy the vehicular environment. In some embodiments, the vehicular environment can include one or more cameras 620 or sensors that can detect the at least one individual and can sense sunlight contact on the at least one individual. The sensors can be IR sensors, non-contact thermal sensors, thermal imaging sensors, RGB cameras, or RGB-IR cameras. The images captured by the RGB camera or sensor can be used to develop a three-dimensional model 640 of the at least one individual in the vehicle. A three-dimensional model is a mathematical coordinate-based graphic representation of the surface of an object in three dimensions: width, length, and height. The model is developed using a specialized software engine to manipulate data points to form various geometric entities such as triangles, rectangles, lines, curved surfaces, etc. In embodiments, the RGB camera 620 can scan at least one individual in a vehicle many times during a trip. The three-dimensional model engine can receive multiple images from one or more RGB cameras and combine them digitally to create a three-dimensional model of each of the at least one individual in the vehicle. Developing the three-dimensional model 640 can be accomplished dynamically using a three-dimensional model engine 630 and can be updated periodically as the vehicle travels.

The infographic 600 can include an estimating engine 650. The estimating engine can use the three-dimensional models of at least one individual and calculate pixel intensity for each model section. Pixel intensity is a measure of pixel brightness. As discussed above, RGB images can be split into red, green, and blue channels resulting in three greyscale images. Greyscale images are made up of pixels with values ranging from 0 to 255. A pixel value of zero represents pure black. A pixel value of 255 represents pure white. Pixel values from 1 to 254 represent various levels of grey, from darkest to lightest. The more pixels in a given area that have values at the high end of the range, the brighter or more intense the sunlight is in that area of the three-dimensional model. The three-dimensional model can be divided into grid areas to evaluate all model sections for pixel intensity. After all model sections have been evaluated, the percent of sunlight coverage per surface area can be determined. The sunlight coverage determination can include a shade intensity metric in some embodiments. A shade intensity metric works similarly to a sunlight intensity metric, but uses the low end of the greyscale numbers instead of the high end. For example, pixels with greyscale values of 0 to 128 can be evaluated as shade, and pixels with greyscale values from 129 to 255 can be evaluated as sunlight. In some embodiments, threshold values can be used to separate the pixel values into discrete groups.

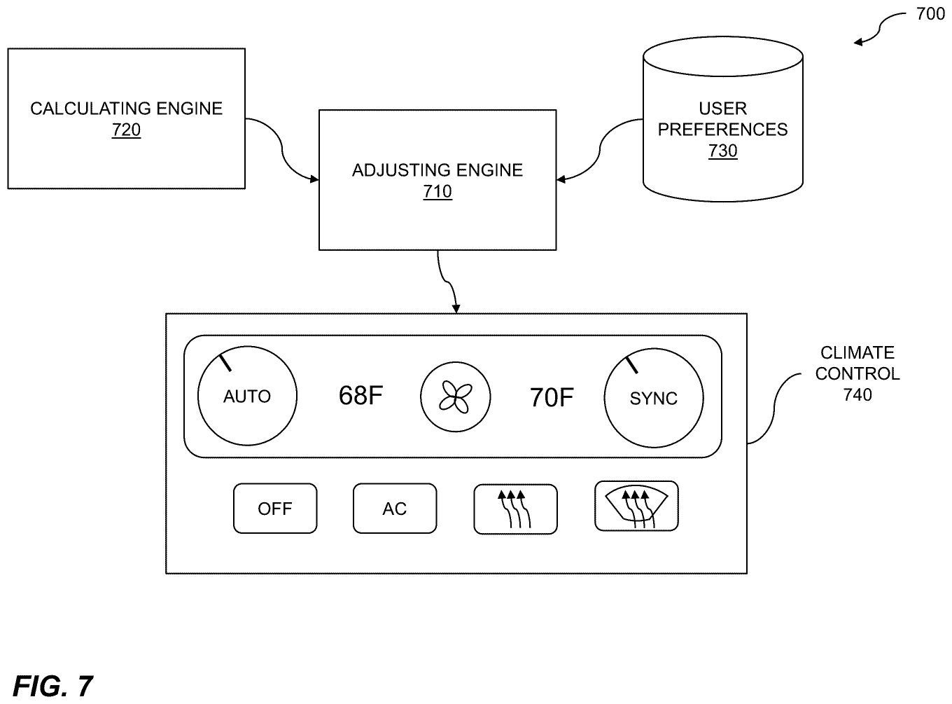

FIG. 7 is an infographic for adjusting the climate control in a vehicle. As discussed above and throughout, at least one individual in a vehicle can be detected by one or more sensors. The sensors can be used to sense sunlight contacting the at least one individual. The images recorded by the one or more sensors can be used to calculate a sunlight intensity metric. The sunlight intensity metric can be used to determine the thermal load on the at least one individual in the vehicle. The thermal load can be used to adjust the climate control in a vehicle to compensate for the thermal load due to sunlight contact on the at least one individual.

The infographic 700 can include a calculating engine 720. In embodiments, IR sensors, non-contact thermal sensors, thermal imaging sensors, RGB cameras, and RGB-IR cameras can be used in a vehicular environment to detect at least one individual in a vehicle. The sensors can sense sunlight contact on the at least one individual. The images from the sensors can be used to calculate a sunlight intensity metric. A three-dimensional model of each individual detected in the vehicular environment can be developed and used to determine the total sunlit surface area of the occupants. Once the model is constructed, it can be divided into segments. Then, each segment can be assigned a sunlight intensity value using the calculated sunlight intensity metric. After each segment has been assigned a sunlight intensity value, the total sunlit surface area can be estimated.

In some embodiments, the sensing can be based on first and second color RGB images. In some embodiments, the color images from the first and second color RGB images can be split into red, green, and blue channels, resulting in greyscale images. The greyscale images are made up of pixels with values from 0 to 255, with each value indicating the amount of light radiating on the associated pixel. In some embodiments, the greyscale images from the first and second RGB color images can be compared based on pixel intensity. Pixel intensity is a measure of pixel brightness. The higher the value of the pixel, the brighter the area of the image and the more intense the light. In some embodiments, the pixel intensity comparison can include a threshold value to aid in the determination of significant changes in pixel values from one image to the next. Comparing greyscale images can be used to determine the total sunlit surface area on the at least one individual in the vehicle. The total sunlit surface area can be combined with the sunlight intensity metric to determine the solar load on the at least one individual.

In embodiments, the calculating engine can determine the solar load on the at least one individual in a vehicle. In some embodiments, the determining can include a shade intensity metric which can be calculated based on the light intensity values captured by the IR or RGB sensors mentioned above. For example, greyscale images can be analyzed for light intensity expressed in pixel values from 0 to 255. Values 0 to 50 can be assigned dark, 51 to 100 full shade, 101 to 150 partial shade, 151 to 200 partial sunlight, and 201 to 255 full sunlight. Using values like these which are assigned to each section of the three-dimensional model, the percentage coverage sunlight can be calculated. In some embodiments, determining the solar load includes accounting for time of day, incidence angle of the sun, length of exposure, and location of sunlight on the at least one individual. The incidence angle is the angle between a ray of light traveling in a straight line from the sun to the surface of an object and the line perpendicular to the surface of the object at the point at which the ray of light strikes. The lower the incidence angle of sunlight, the more direct the solar contact and the higher the intensity. Solar load increases with more direct, higher-intensity solar contact. In some embodiments, determining the solar load includes recognizing the clothing of at least one individual in the vehicle. The recognizing of clothing can be accomplished dynamically. Multiple images of the at least one individual can make clothing more easily recognizable as different portions of the clothing fold or billow or as the pattern on the clothing shifts significantly. The thermal properties of the clothing can also be used in determining the solar load. The clothing and thermal properties of the clothing can be based on machine learning. Machine learning can be used to provide and maintain details regarding clothing materials, colors, and thermal properties. In some embodiments, the solar load determination can be based on a two-dimensional model of the at least one individual. A two-dimensional model is a flat shape with two dimensions—length and width. The model can be based on the images recorded by RGB or IR sensors in the vehicular environment. A two-dimensional model allows the greyscale pixels to be laid out across the model and quickly evaluated for the percentage of sunlight and shade contacting each individual in the vehicle. In some embodiments, the solar load determination can include color temperature. Color temperature measures the color of a light source, such as the sun, measured in kelvin. The higher the value of the color temperature, the whiter the light. Using a known color within the vehicle for calibration, the color temperature setting required to match the template color can provide information regarding the brightness of the sunlight contacting the individuals within the vehicle. In some embodiments, determining solar load can include the exterior temperature around a vehicle. The temperature of the air flowing through a vehicle can affect the thermal load on the at least one individual in the vehicle.

The infographic 700 can include an adjusting engine 710. In embodiments, the adjusting engine can change the settings of a climate control 740 in a vehicle. The adjusting can be based on the calculated solar load on the at least one individual in a vehicular environment. The at least one individual in a vehicular environment can be comprised of a first individual and a second individual. In some embodiments, determining the solar load can be based on determining an aggregate solar load on the first individual and the second individual. In other embodiments, determining the solar load can be based on a first solar load on the first individual and determining a second solar load on the second individual. In such cases, the temperature controls from the climate control in the vehicle are controlled independently for the first individual and the second individual.

The infographic 700 can include user preferences 730. In embodiments, a profile of user preferences can be established for the at least one individual in the vehicle. The profile can include preferences for temperature, airflow, and window position. In some embodiments, the adjusting engine 710 can take the user preferences 730 into account when determining the adjustment to the climate control 740. In some embodiments, the adjusting can include the time of day, season, time of year, drive time, geographic location information, make and type of vehicle, and capabilities of the climate control system. The adjusting can include opening one or more windows in the vehicle, and using a vehicle seat heater or seat cooler. In some embodiments, newer vehicles include separate climate controls for rear-seat passengers. User preferences can be established for rear-seat individuals, and climate control adjustments can be made as described above for the first and second individuals in a vehicle.

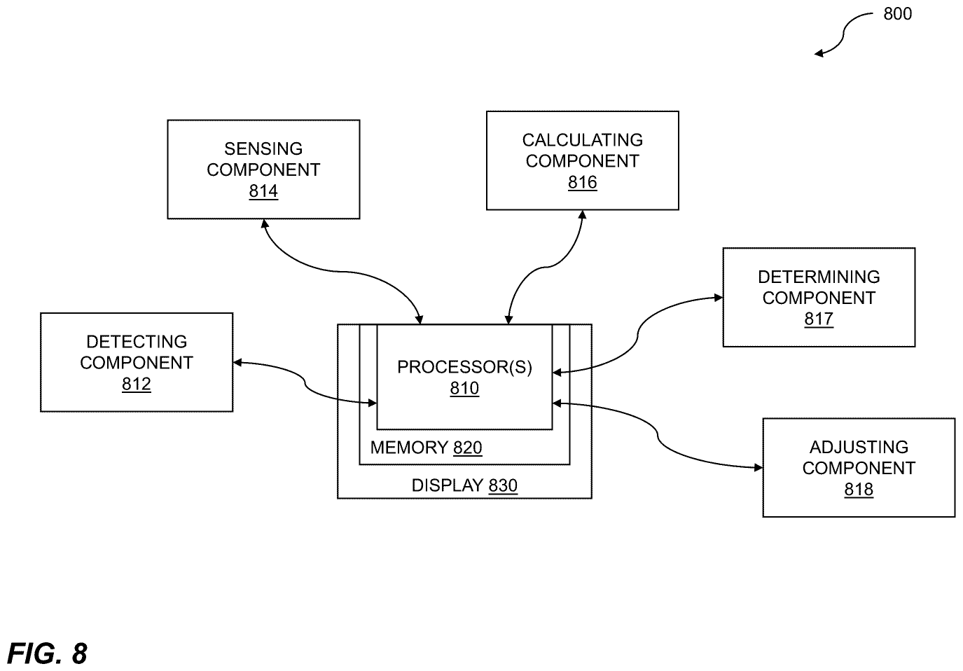

FIG. 8 is a system diagram for solar load usage in a vehicular environment. The system 800 can include one or more processors 810 coupled to a memory 820, which stores instructions. The system 800 can include a display 830 coupled to the one or more processors 810 for displaying data, video streams, videos, video metadata, product information, auction bid information, editing information, system logs, webpages, intermediate steps, instructions, and so on. In embodiments, one or more processors 810 are coupled to the memory 820 where the one or more processors, when executing the instructions which are stored, are configured to: detect, using one or more processors, at least one individual in a vehicular environment; sense sunlight contact with the at least one individual; calculate a sunlight intensity metric, wherein the sunlight intensity metric is based on the sensing; determine a thermal load, on the at least one individual, wherein the thermal load results from the sunlight contact and wherein the determining is based on the sunlight intensity metric; and adjust a climate control within a vehicle, from the vehicular environment, based on the determining the thermal load, wherein the adjusting compensates for the thermal load.

The system 800 can include a detecting component 812. The detecting component 812 can include functions and instructions for detecting at least one individual in a vehicular environment. In embodiments, the detecting can be accomplished by an IR sensor, non-contact thermal sensor, thermal imaging sensor, RGB camera, or RGB-IR camera. The system 800 can include a sensing component 814. The sensing component 814 can include functions and instructions for sensing sunlight contact with the at least one individual in a vehicular environment. In embodiments, the sensing can be accomplished by an IR sensor, non-contact thermal sensor, thermal imaging sensor, RGB camera, or RGB-IR camera. In some embodiments, the sensing can be based on a first color RGB image. The sensing can further comprise splitting the first color image into red, green, and blue (RGB) channels, resulting in three greyscale images. The splitting can further include a second color RGB image. The greyscale images based on the first color RGB image and the greyscale images based on the second color RGB image can be compared. The comparing can be based on pixel intensity. The pixel intensity comparison can include a threshold variable. In addition, the time elapsed between the first and second color RGB images can be variable.

The system 800 can include a calculating component 816. The calculating component 816 can include functions and instructions for calculating a sunlight intensity metric based on the sensing component 814. The calculating component 816 can include functions and instructions for determining the thermal load on the at least one individual in the vehicular environment, wherein the thermal load results from the sunlight contact and wherein the determining is based on the sunlight intensity metric. The thermal load resulting from sunlight contact can comprise a solar load.

The system 800 can include a determining component 817. The determining component can determine a thermal load, on the at least one individual, wherein the thermal load results from the sunlight contact and wherein the determining is based on the sunlight intensity metric. Determining the solar load can include developing a three-dimensional model of the at least one individual, wherein the developing is accomplished dynamically, and wherein the determining further comprises estimating the total sunlit surface area of the at least one individual, wherein the estimating is based on the three-dimensional model. In some embodiments, the estimating includes sunlight intensity per surface area of the at least one individual, wherein the sunlight intensity per surface area is based on the sunlight intensity metric. Determining the solar load can be based on the percent sunlight coverage on at least one individual. In some embodiments, the determining can include a shade intensity metric wherein the sunlight intensity metric is compared with the shade intensity metric. The determining can include accounting for time of day, the incidence angle of the sun, length of exposure, or location of sunlight on the at least one individual. The determining can include dynamically recognizing the clothing of at least one individual, wherein the determining includes the thermal properties of the clothing. In some embodiments, the recognizing can be based on machine learning. In some embodiments, the determining can be based on a two-dimensional model of the at least one individual. The determining can include color temperature and exterior temperature.

The system 800 can include an adjusting component 818. The adjusting component 818 can include functions and instructions for adjusting a climate control within a vehicle, from the vehicular environment, based on the determining thermal load, wherein the adjusting compensates for the thermal load. In embodiments, the adjusting is based on changes in the thermal load over time. The adjusting further comprises establishing a profile for the at least one individual, wherein the profile includes preferences for temperature, airflow, and window position. The profile can also include the time of day, season, time of year, drive time, geographic location information, make and type of vehicle, or capability of the climate controls. In some embodiments, the adjusting the climate control can include opening a window in the vehicle, or using a vehicle seat heater or a seat cooler.

The system 800 can include computer program product embodied in a non-transitory computer readable medium for solar load analysis, the computer program product comprising code which causes one or more processors to perform operations of: detecting, using one or more processors, at least one individual in a vehicular environment; sensing sunlight contact with the at least one individual; calculating a sunlight intensity metric, wherein the sunlight intensity metric is based on the sensing; determining a thermal load, on the at least one individual, wherein the thermal load results from the sunlight contact and wherein the determining is based on the sunlight intensity metric; and adjusting a climate control within a vehicle, from the vehicular environment, based on the determining the thermal load, wherein the adjusting compensates for the thermal load.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for solar load analysis comprising:
detecting, using one or more processors, at least one individual in a vehicular environment;
sensing sunlight contact with the at least one individual;
calculating a sunlight intensity metric, wherein the sunlight intensity metric is based on the sensing;
determining a thermal load, on the at least one individual, wherein the thermal load results from the sunlight contact and wherein the determining is based on the sunlight intensity metric; and
adjusting a climate control within a vehicle, from the vehicular environment, based on the determining the thermal load, wherein the adjusting compensates for the thermal load.

2. The method of claim 1 wherein the determining further comprises a three-dimensional model of the at least one individual.

3. The method of claim 2 wherein the determining further comprises estimating total sunlit surface area of the at least one individual, wherein the estimating is based on the three-dimensional model.

4. The method of claim 3 wherein the estimating includes sunlight intensity per surface area of the at least one individual, wherein the sunlight intensity per surface area is based on the sunlight intensity metric.

5. The method of claim 2 wherein the determining is based on percent of sunlight coverage on the at least one individual.

6. The method of claim 1 wherein the determining includes a shade intensity metric, wherein the sunlight intensity metric is compared with the shade intensity metric.

7. The method of claim 1 wherein the determining includes accounting for time of day, incidence angle of the sunlight, length of exposure, or location of sunlight on the at least one individual.

8. The method of claim 1 wherein the determining further comprises recognizing clothing of the at least one individual and including thermal properties of the clothing of the at least one individual.

9. The method of claim 1 wherein the determining includes factoring in an estimated body mass of the at least one individual.

10. The method of claim 1 wherein the sensing is based on a first color RGB image.

11. The method of claim 10 further comprising splitting the first color image into red, green, and blue (RGB) channels, wherein the splitting results in three greyscale images.

12. The method of claim 11 wherein the splitting includes a second color RGB image.

13. The method of claim 12 further comprising comparing the greyscale images based on the first color RGB image and the greyscale images based on the second color RGB image, wherein the comparing is based on pixel intensity.

14. The method of claim 13 wherein the comparing includes a threshold value.

15. The method of claim 12 wherein time elapsed between the first color image and second color image is variable.

16. The method of claim 1 wherein the determining is based on a two-dimensional model of the at least one individual.

17. The method of claim 1 wherein the determining includes color temperature and/or exterior temperature.

18. The method of claim 1 wherein the adjusting is further based on a profile established for the at least one individual.

19. The method of claim 1 wherein the climate control is based on changes in the thermal load over time.

20. The method of claim 1 wherein the at least one individual in the vehicular environment comprises a first individual and a second individual.

21. The method of claim 20 wherein the determining the thermal load comprises determining an aggregate thermal load on the first individual and the second individual.

22. The method of claim 20 wherein the determining the thermal load comprises determining a first thermal load on the first individual and determining a second thermal load on the second individual.

23. The method of claim 22 wherein temperature controls, from the climate control in the vehicle, are controlled independently for the first individual and the second individual.

24. The method of claim 1 wherein the adjusting the climate control includes use of a vehicle seat heater or a seat cooler.

25. A computer program product embodied in a non-transitory computer readable medium for solar load analysis, the computer program product comprising code which causes one or more processors to perform operations of:
detecting, using one or more processors, at least one individual in a vehicular environment;
sensing sunlight contact with the at least one individual;
calculating a sunlight intensity metric, wherein the sunlight intensity metric is based on the sensing;
determining a thermal load, on the at least one individual, wherein the thermal load results from the sunlight contact and wherein the determining is based on the sunlight intensity metric; and
adjusting a climate control within a vehicle, from the vehicular environment, based on the determining the thermal load, wherein the adjusting compensates for the thermal load.

26. A computer system for solar load analysis comprising:
a memory which stores instructions;
one or more processors coupled to the memory wherein the one or more processors, when executing the instructions which are stored, are configured to:
detect, using one or more processors, at least one individual in a vehicular environment;
sense sunlight contact with the at least one individual;
calculate a sunlight intensity metric, wherein the sunlight intensity metric is based on sensing;
determine a thermal load on the at least one individual, wherein the thermal load results from the sunlight contact and wherein determination is based on the sunlight intensity metric; and
adjust a climate control within a vehicle, from the vehicular environment, based on the thermal load that was determined, wherein adjustment compensates for the thermal load.
